(19) United States
(12) Patent Application Publication
(10) Pub. No.: US 2015/0122708 A1
(43) Pub. Date: May 7, 2015

(54) PIN SORTER

(71) Applicants: Corey Gonnella, Aberdeen, MD (US); Steven Ko, City of Industry, CA (US)

(72) Inventors: Corey Gonnella, Aberdeen, MD (US); Steven Ko, City of Industry, CA (US)

(21) Appl. No.: 14/536,573

(22) Filed: Nov. 7, 2014

Related U.S. Application Data
(60) Provisional application No. 61/901,291, filed on Nov. 7, 2013.

(51) Int. Cl. B03C 1/18; B07B 1/28

(52) U.S. Cl. CPC B03C 1/18; B07B 1/28
USPC 209/636; 209/659; 209/680

(57) ABSTRACT

A system for sorting merchandise tags. The system includes a housing configured to receive a first portion of the merchandise tag and a second portion of the merchandise tag, the first portion and the second portion configured to attach to one another. The system also includes a separator configured to separate the first portion and the second portion based on one or more physical characteristics of the first portion and the second portion. The system further includes a rotating mechanism, where the rotating mechanism allows the user to control the separator. The system additionally includes a container for receiving the smaller portion which falls through the separator.

### CROSS-REFERENCE TO RELATED APPLICATIONS

This application claims the benefit of and priority to U.S. Provisional Patent Application Ser. No. 61/901,291 filed on Nov. 7, 2013, which application is incorporated herein by reference in its entirety.

### BACKGROUND OF THE INVENTION

Merchandise tags are used for a variety of reasons. For example, the merchandise tag can identify certain products, can prevent theft or can be used to display the merchandise. These tags almost always include two pieces that are connected to one another through the merchandise or merchandise packaging. I.e., when the item is sold the merchant removes the portions of the merchandise tag so that the tag can be used later.

However, these tags normally have to be sorted by hand. I.e., at the time of removal the two pieces are simply thrown into bins together. This means that to be used in the future they must be sorted by hand or the user must go through the collection looking for mating parts. This is a slow process and can lead to injury. In particular, to lock together the tag normally has a “pin” on one portion that is inserted into the mating portion. An employee pushing his/her hands into containers of merchandise tags is bound to result in cuts or more serious injuries.

Nevertheless, because the merchandise tags can be expensive there is an overwhelming incentive to reuse the tags. Therefore, employees have no choice but to be careful during the sorting process.

Accordingly, there is a need in the art for a system that can automatically sort the mating parts of a merchant tag. Further, there is need in the art for the system to be able to sort based on different physical characteristics.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for sorting merchandise tags. The system includes a housing configured to receive a first portion of the merchandise tag and a second portion of the merchandise tag, the first portion and the second portion configured to attach to one another. The system also includes a separator configured to separate the first portion and the second portion based on one or more physical characteristics of the first portion and the second portion. The system further includes a rotating mechanism, where the rotating mechanism allows the user to control the separator. The system additionally includes a container for receiving the smaller portion which falls through the separator.

Another example embodiment includes a system for sorting merchandise tags. The system includes a housing configured to receive the pins and the backings of merchandise tags where either the pin or the backing but not both constitutes a larger portion and the other constitutes a smaller portion. The system also includes a separator configured to separate the larger portion and the smaller portion. The system further includes an agitator configured to move the separator. The system additionally includes a container for receiving the smaller portion which falls through the separator.

Another example embodiment includes a system for sorting merchandise tags. The system includes a housing configured to receive the pins and the backings of merchandise tags, where either the pin or the backing but not both constitutes a magnetic portion and the other constitutes a non-magnetic portion. The system also includes a separator configured to separate the magnetic portion and the non-magnetic portion. The separator includes a first roller and a second roller, where the second roller is magnetic. The separator also includes a conveyor belt disposed between the first roller and the second roller. The magnetic portion is magnetically attracted to the second roller. The system further includes a rotating mechanism for moving the conveyor belt along the path defined by the first roller and the second roller. The conveyor belt allows non-magnetic portion to fall into a first container and the conveyor belt moves the magnetic portion along the path to fall into a second container.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a pin sorter;

FIG. 2A illustrates a front perspective view of the example of a pin sorter with the lid open;

FIG. 2B illustrates a rear perspective view of the example of a pin sorter with the lid open;

FIG. 2C illustrates a top perspective view of the example of a pin sorter with the lid open;

FIG. 2D illustrates a left perspective view of the example of a pin sorter with the lid removed;

FIG. 3 illustrates an example of the pin sorter with the release unfastened;

FIG. 4 illustrates an example of a pin sorter with merchandise tags in the receptacle; and

FIG. 5 illustrates an example of a pin sorter for sorting magnetic merchandise tags.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

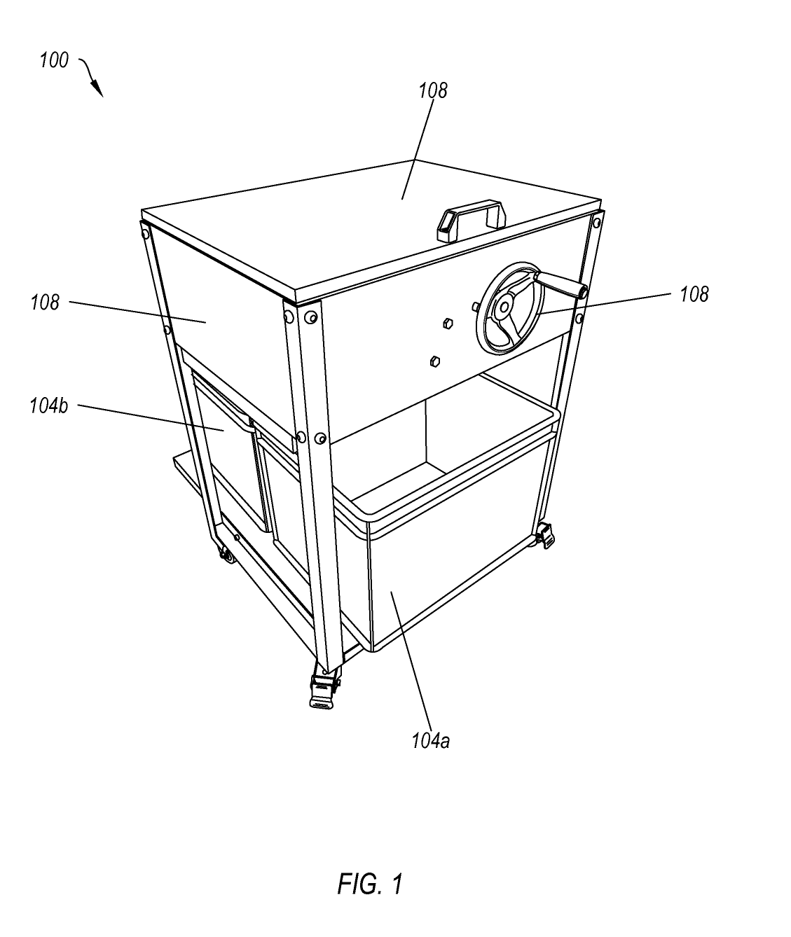

FIG. 1 illustrates an example of a pin sorter 100. The pin sorter 100 is configured to separate the two sides of a merchandise tag (the “pin” and the “backing” which are sometimes different sizes) and sorts them so that they can be reused by a retailer. I.e., the pin and the backing are placed in different bins to allow the retailer to quickly obtain a pin and backing to place on merchandise. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 1 shows that the pin sorter 100 can include a housing 102. The housing 102 is configured to receive the pins and the backings. I.e., a user can deposit the pins and backings into a single container. For example, as clerks remove the merchandise tag at the time of sale, the merchandise tags may be placed in a single bin. The clerks then place the unsorted tags into the housing 102. The housing 102 can include a lid to prevent shaking (see below) from causing the pins and backing to exit the housing 102 during sorting.

FIG. 1 also shows that the pin sorter 100 can include a first container 104a and a second container 104b (collectively “containers 104”) for receiving the backings and the pins. For example, the first container 104a can be placed under the pin sorter 100 during the first phase of sorting, where one portion of the merchandise tag (either the pin or the backing) falls into the first container 104a. The second container 104b is then used to receive the remaining portion of the merchandise tag. The containers 104 can be a built in container or can be a container supplied by the user. For example, the containers 104 can include drawers on the pin sorter 100 or can include bins that can be placed under the pin sorter 100 by a user.

FIG. 1 further shows that the pin sorter 100 can include a rotating mechanism 106. The rotating mechanism 106 can be turned by a user controlling the sorting of the merchandise tags, allowing for separation. I.e., turning the rotating mechanism 106 allows a user to activate the sorting mechanism, as described below. The rotating mechanism 106 can include any device configured to control the sorting of the tags. For example, the rotating mechanism 106 can include a hand wheel, a crank or an electric motor.

FIG. 1 additionally shows that the pin sorter 100 can include a lid 108. The lid 108 prevents pins and backings from leaving the housing 102. I.e., as the merchandise tags undergo sorting they are retained within the housing 102 by the lid 108. The lid 108 can include a latch to prevent unwanted opening. For example, the latch can include a mechanical latch or a magnetic latch.

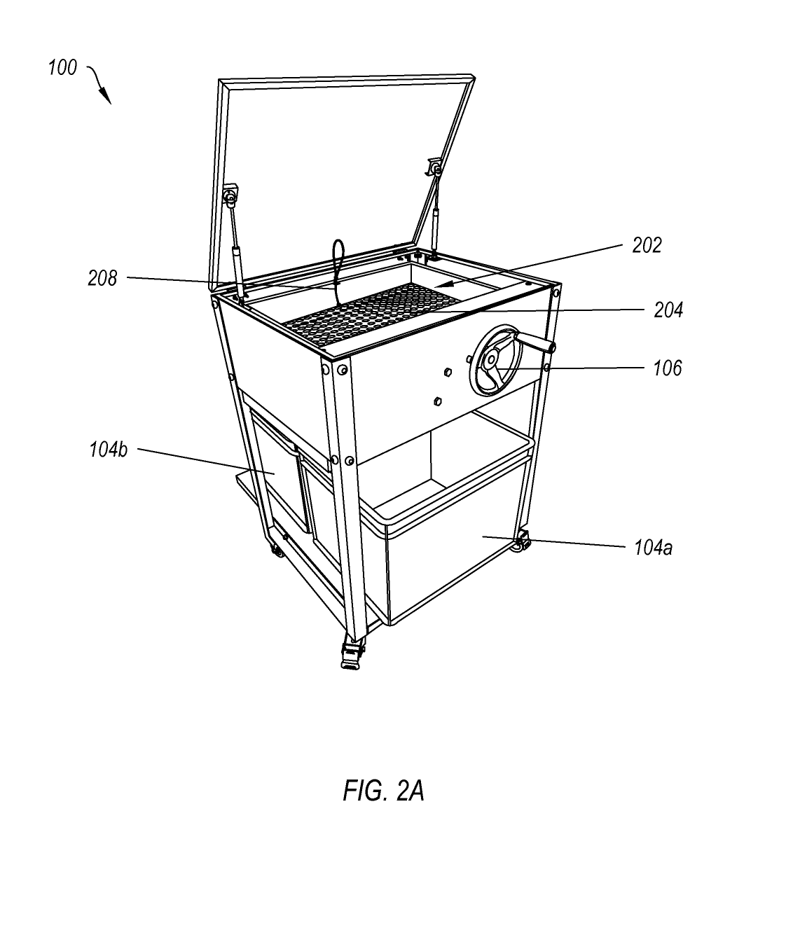

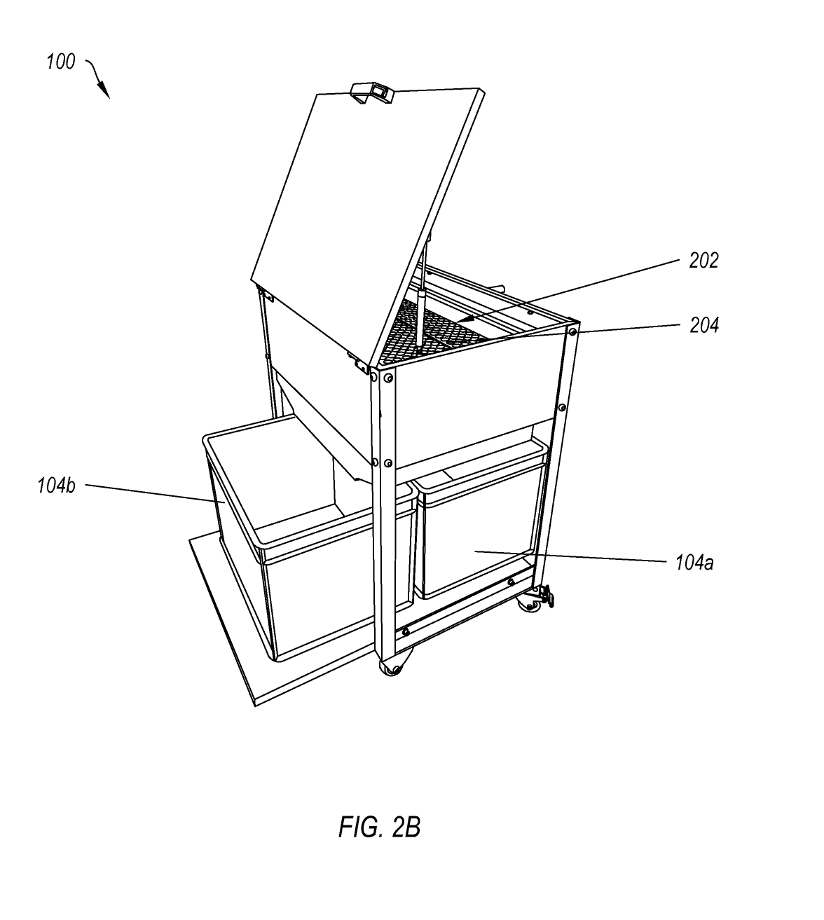

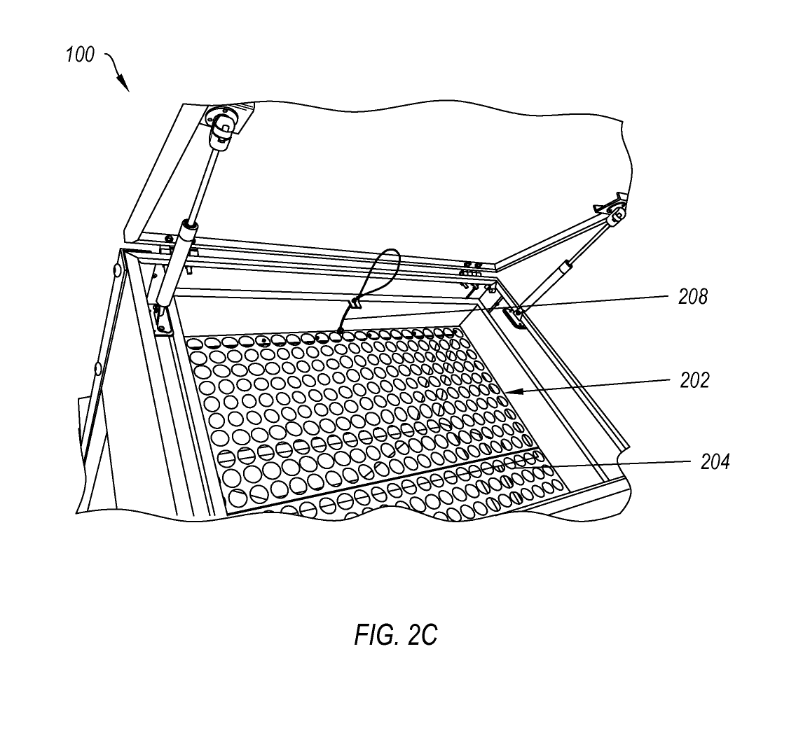

FIGS. 2A, 2B, 2C and 2D (collectively “FIG. 2”) illustrate an example of a pin sorter 100 with the lid 108 open. FIG. 2A illustrates a front perspective view of the example of a pin sorter 100 with the lid 108 open; FIG. 2B illustrates a rear perspective view of the example of a pin sorter 100 with the lid 108 open; FIG. 2C illustrates a top perspective view of the example of a pin sorter 100 with the lid 108 open; and FIG. 2D illustrates a left perspective view of the example of a pin sorter 100 with the lid 108 removed. When the lid 108 is open the pin sorter 100 can receive merchandise tags. I.e., a user can place the lid 108 in an open position, allowing the merchandise tags to be placed for sorting.

FIG. 2 shows that the pin sorter 100 can include a receptacle 202. The receptacle 202 receives the merchandise tags for sorting. I.e., the vendor takes the collecting backings and pins and places them in the receptacle 202. Typically, the pins and backings will be collected by a cashier or other employee. Merchandise tags from multiple employees, shifts, etc. can then be collectively placed in the receptacle 202.

FIG. 2 shows that the pin sorter 100 can include a separator 204. The separator 204 is configured to separate the pins and the backings from one another. In some cases the pins and backings are of different sizes and can be separated on the basis of size. For example, the separator 204 can include a lattice in the bottom of the receptacle 202. The lattice includes holes through which the backings can fall, if smaller, but which are two small to allow the pins, if larger, to pass.

FIG. 2 further shows that the pin sorter 100 can include an agitator 206. The agitator 206 is configured to shake the merchandise tags, allowing for separation. I.e., the agitator 206 provides physical agitation, allowing each pin/backing to come into contact with the separator 204 during sorting, as described below. For example, the agitator 206 can convert the circular movement of the rotating mechanism 106 to a back and forth lateral motion in the separator 204. The agitator 206 can include any device configured to move the separator 204. For example, the agitator 206 can include a cam or other mechanism. As the agitator 206 causes movement of the separator 204 the pins and backings are shuffled. The smaller of the pins and backings will then fall through the holes to be collected in the first container 104a while the larger of the pins and backings will remain above the separator 204 in the receptacle 202.

FIG. 2 also shows that the pin sorter 100 can include a release 208. The release 208 allows a user to remove portions of the merchandise tag that remain in the receptacle 202. I.e., either the pin or the backing will be too large to pass through the separator 204 and remain in the receptacle 202. The release 208 allows the remaining portion to be placed into the second container 104b. For example, the separator 204 can include a hinge or other mechanism to allow the separator 204 to drop the retained pins or backings after sorting into the second container 104b.

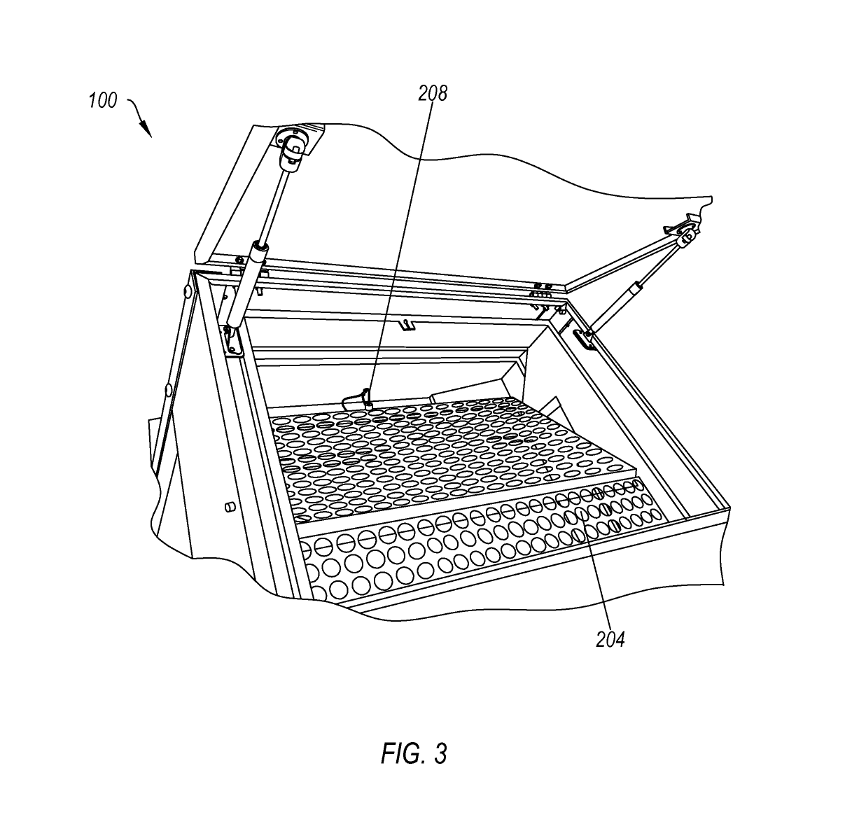

FIG. 3 illustrates an example of the pin sorter 100 with the release 208 unfastened. Unfastening the release 208 allows a portion of the separator 204 to “drop” or form a ramp. The remaining portion of the merchandise tag then drops into the second container. I.e., unfastening the release 208 creates an opening through which the remaining portion of the merchandise tag may be removed from the receptacle 202.

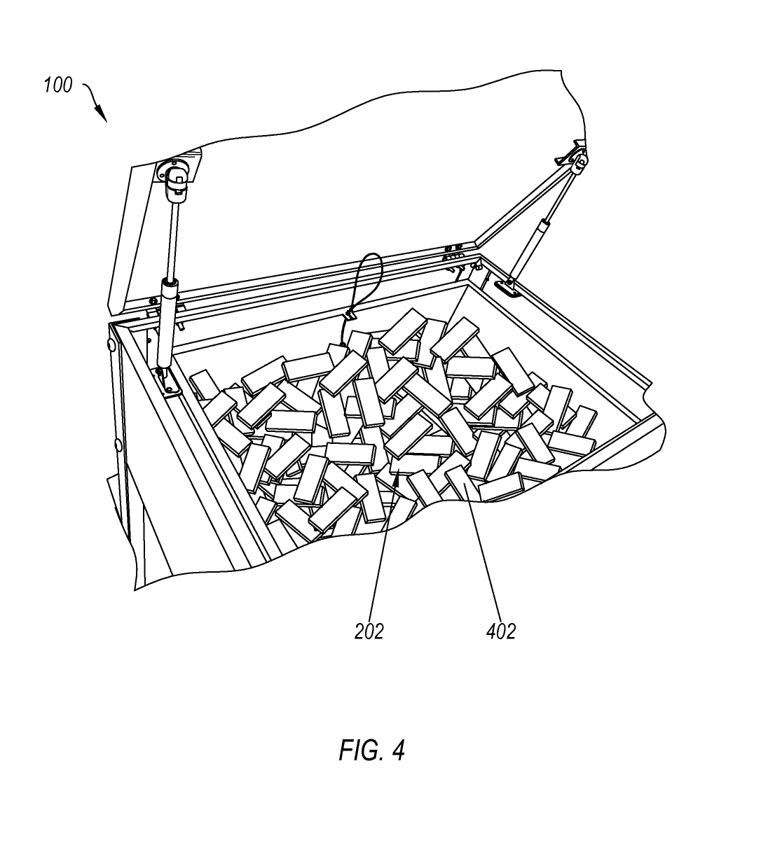

FIG. 4 illustrates an example of a pin sorter 100 with merchandise tags 402 in the receptacle 202. The merchandise tags 402 consist of pins and backings that are not currently connected to one another. I.e., the merchandise tags 402 connect to one another through an item to identify merchandise, prevent theft, etc. When disconnected they are placed in the receptacle 202 to be sorted for future use.

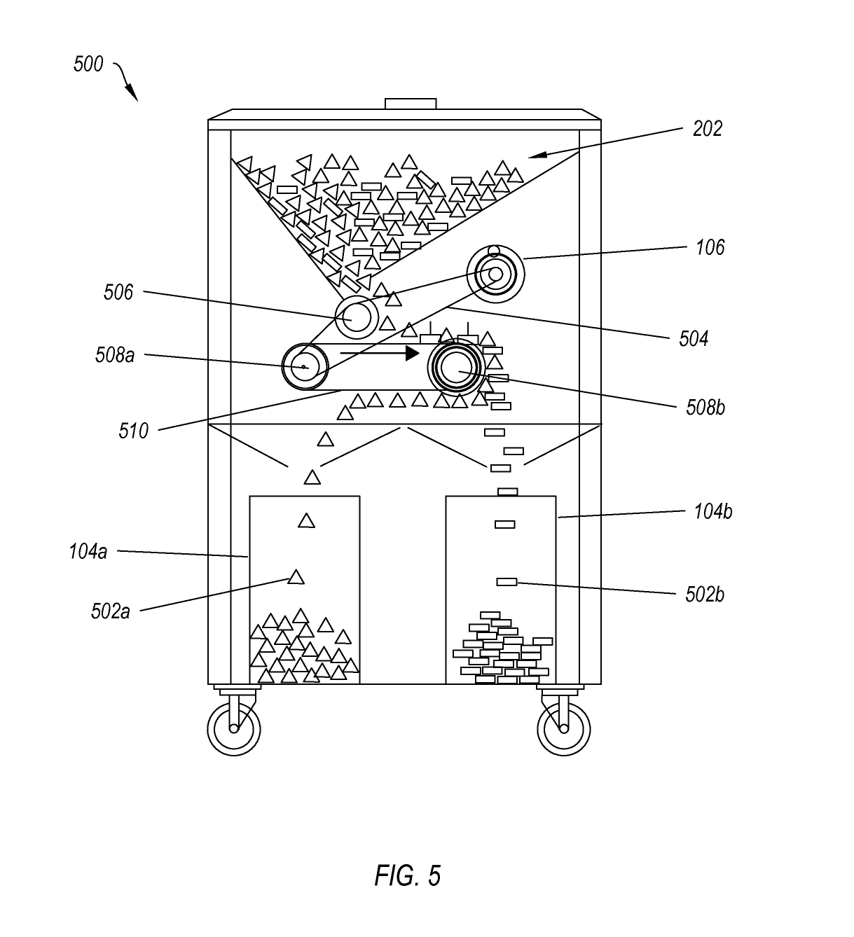

FIG. 5 illustrates an example of a pin sorter 500 for sorting magnetic merchandise tags. Some merchandise tags do not include pins and backings that are substantially different in size. I.e., the pin is approximately the same size as the backing. Therefore, sorting the pin from the backing cannot be done on the basis of size. However, in some instances either the pin or the backing is magnetic (the “magnetic portion 502a”) and the other is non-magnetic (the “non-magnetic portion 502b”). Therefore, the pin sorter 500 uses a magnetic system.

FIG. 5 also shows that the pin sorter 500 can include a belt 504. The belt 504 transfers the rotational movement of the rotating mechanism 106 to rotation of other portions of the pin sorter 500. I.e., the belt 504 provides a physical connection which transfers rotation of the rotating mechanism 106 into motion within other parts of the pin sorter, allowing parts to remain synchronized and allowing for a single input of power.

FIG. 5 also shows that the pin sorter 500 can include a feeder roller 506. The feeder roller 506 pushes pins and backings from the receptacle 202. The feeder then releases only a limited number of pins and backings for sorting. I.e., the feeder roller 506 allows a predetermined number of pins and backings to be sorted over a specified time frame. For example, the receptacle 202 can include a narrow opening at which pins and backings will become stuck unless the feeder roller is moving. I.e., as the feeder spins, it pushes a pin or tag backing an opening in the receptacle sideways where the pin or backing is sorted. The feeder roller 506 is connected to the belt 504 allowing a user to control the rate at which the feeder roller 506 releases pins and backings from the receptacle 202.

FIG. 5 further shows that the pin sorter 500 can include a first roller 508a and a second roller 508b (collectively “rollers 508”). The rollers 508 turn a conveyor belt 510. Either the first roller 508a or the second roller 508b or both are connected to the belt 504 moving the conveyor belt 510 around a path defined by the rollers 508. As pins and backings are released by the feeder roller 506 they land on the conveyor belt 510 where they are moved along the path. As the conveyor belt 510 moves around the second roller 508b the pins and backings would tend to fall under the influence of gravity into the first container 104a. However, if the second roller 508b is magnetic then the magnetic portion 502a is attracted to the conveyor belt 510 and does not fall into the first container 104a but the non-magnetic portion 502b is not attracted and does fall into the first container 104a. The magnetic portion 502a of the merchandise tag continues along the path until the distance between the magnetic portion 502a and the second roller 206b weakens the magnetic attraction sufficiently to allow the magnetic portion 502a to fall into the second container 104b.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for sorting merchandise tags, the system comprising:
a housing:
configured to receive a first portion of the merchandise tag and a second portion of the merchandise tag, the first portion and the second portion configured to attach to one another; and
a separator:
configured to separate the first portion and the second portion based on one or more physical characteristics of the first portion and the second portion; and
a rotating mechanism, wherein the rotating mechanism allows the user to control the separator; and
a container for receiving the smaller portion which falls through the separator.

2. The system of claim 1, wherein the one or more physical characteristics includes magnetic properties.

3. The system of claim 1, wherein the one or more physical characteristics includes size of the first portion relative to the second portion.

4. The system of claim 1, further comprising:
a lid to prevent the first portion and the second portion from exiting the housing during separating.

5. The system of claim 1, wherein the rotating mechanism includes a motor.

6. The system of claim 1, wherein the rotating mechanism includes a hand wheel.

7. The system of claim 1, wherein the housing includes a receptacle configured to receive the first portion and the second portion.

8. A system for sorting merchandise tags, the system comprising:
a housing:
configured to receive the pins and the backings of merchandise tags wherein either the pin or the backing but not both constitutes a larger portion and the other constitutes a smaller portion; and
a separator:
configured to separate the larger portion and the smaller portion; and
an agitator configured to move the separator; and
a container for receiving the smaller portion which falls through the separator.

9. The system of claim 8, wherein the separator includes
a hinge configured to allow at least a portion of the separator to move, dropping the larger portion into a second container.

10. The system of claim 9, further comprising a release configured to:
prevent the separator from moving at the hinge when locked; and
allow the separator to move at the hinge when unlocked.

11. The system of claim 8, wherein the separator includes:
a lattice with holes through which the small portion can fall and the larger portion cannot fall.

12. The system of claim 8, wherein the agitator converts the circular movement of the rotating mechanism to a back and forth lateral motion in the separator.

13. The system of claim 8, wherein the pin is the larger portion.

14. The system of claim 8, wherein the backing is the larger portion.

15. A system for sorting merchandise tags, the system comprising:
a housing:
configured to receive the pins and the backings of merchandise tags, wherein either the pin or the backing but not both constitutes a magnetic portion and the other constitutes a non-magnetic portion; and
a separator:
configured to separate the magnetic portion and the non-magnetic portion; and
including:
a first roller;
a second roller, wherein the second roller is magnetic; and
a conveyor belt disposed between the first roller and the second roller; and
wherein the magnetic portion is magnetically attracted to the second roller;
a rotating mechanism for moving the conveyor belt along the path defined by the first roller and the second roller;
wherein the conveyor belt allows non-magnetic portion to fall into a first container; and
wherein the conveyor belt moves the magnetic portion along the path to fall into a second container.

16. The system of claim 15, further comprising a belt connecting the rotating mechanism to the first roller.

17. The system of claim 16, further comprising a feeder roller configured to release only a limited number of pins and backings to move along the conveyor belt.

18. The system of claim 17, wherein the belt connects the rotating mechanism to the feeder roller.

19. The system of claim 17, wherein the housing includes a receptacle configured to receive the first portion and the second portion.

20. The system of claim 19, wherein the receptacle includes an opening near the feeder roller.
